(19) United States
(12) Patent Application Publication
(10) Pub. No.: US 2007/0213867 A1
(43) Pub. Date: Sep. 13, 2007

(54) Method for compensating thermal displacements

(76) Inventors: Dirk Prust, Tuttlingen (DE); Hans-Henning Winkler, Tuttlingen (DE)

Correspondence Address: HARNESS, DICKEY & PIERCE, P.L.C., P.O. BOX 828, BLOOMFIELD HILLS, MI, 48303, US

(21) Appl. No.: 11/716,850

(22) Filed: Mar. 12, 2007

Related U.S. Application Data
(63) Continuation of application No. PCT/EP05/06783, filed on Jun. 23, 2005.

(30) Foreign Application Priority Data
Sep. 13, 2004 (DE) 10 2004 044 838.8

(51) Int. Cl. G06F 19/00

(52) U.S. Cl. 700/193

(57) ABSTRACT

A method for compensating thermal displacements is carried out on a machine tool having a worktable for mounting workpieces to be machined, and having a tool spindle which can be traversed relative to the worktable on at least one axis and into which it is possible to clamp tools with the aid of which a machining process is carried out on the workpieces. In this case a calculating rule is used to calculate from at least one temperature value currently measured at a measuring point on the machine tool at least one correction value for the at least one axis. The calculating rule is tuned in this case to the respective machining process.

This is a continuation application of International Patent Application PCT/EP/2005/006783, filed Jun. 23, 2005, designating the United States and published in German as WO 2006/029662 A1, which claims priority to German application No. 10 2004 044 838, filed Sep. 13, 2004.

### BACKGROUND OF THE INVENTION

1. Field of the Invention

The present invention relates to a method for compensating thermal displacements in the case of a machine tool having a worktable for mounting workpieces to be machined, and having a tool spindle which can be moved relative to the worktable in at least one axis and into which tools can be clamped for performing a machining process on the workpieces, a calculating rule being used to calculate from at least one temperature value currently measured at a measuring point on the machine tool at least one correction value for the at least one axis.

2. Related Prior Art

Such a method is known from DE 42 03 994 A1.

The requirements placed on the machining accuracy of modern machine tools have been growing more and more in recent years, and in the meantime machining accuracies in the range of a few μm are being required for many applications. Thermal displacements which a machine tool is subjected to, for example owing to heating of its individual assemblies, are also becoming noticeable in such an accuracy range.

Thus, it is known that a machine tool requires a number of hours until it has reached thermal equilibrium such that no relatively large thermal fluctuations, and thus no associated displacements, occur any longer in the case of a repeatedly recurring machining process.

In order not to have to wait after each time an operationally cold machine is switched on, for example in the morning as a shift begins, until the respective machine tool is at thermal equilibrium, various methods are known from the prior art for the purpose of determining corresponding correction values which are taken into account in the positioning instruction in the machine tool.

The aim of this is to render it possible to be able to use an as yet cold machine tool to machine workpieces with the same, or a comparable, accuracy as with a machine tool at thermal equilibrium.

In DE 42 03 994 A1 mentioned at the outset, it is proposed to this end to measure temperature values at various points of a machine tool and to use a calculating rule to determine from these temperature values correction values with the aid of which the actual values, detected with a measuring system, of the relative position of the tool spindle in relation to the work table are corrected. In other words, the actual value, measured by the measuring system, of the spindle position is corrected by a calculated error value which is calculated from the measured temperatures. The aim thereby is, for example, to compensate the thermally induced expansion of a scale of lengths.

To this end, the so-called calculating rule is being developed for the appropriate machine type; it is used in the individual machining processes in order to determine the correction values for the appropriate axes. These axes can be, for example, the three orthogonal axes X, Y and Z, and also swivel or rotation axes.

It has emerged that it is impossible, even with a large number of measuring points, to obtain a sufficiently accurate description of the temperature behaviour of a machine tool, and so it is frequently impossible to compensate with the desired accuracy.

Against this background, the path to directly measuring the actual displacement is being taken in addition to the calculation of correction values that is based on a temperature measurement, or as an alternative thereto.

A relevant method is described in U.S. Pat. No. 5,581,467. In the known method, a reference point relating to the origin of coordinates is defined either on the work table or on the workpiece to be machined, and correction values are determined which are used to calculate for the controller traversing instructions which take account of thermal displacements.

To this end, the actual position of the reference point is measured at specific intervals and the current correction values are calculated therefrom and then used for the correction. The frequency with which the current position of the reference point is measured is adapted to the thermal state of the machine tool as a function of the deviations in the currently determined correction values relative to the correction values from the last measuring operation. The fewest possible measurements are always carried out in this way when the thermal displacement remains within prescribed values.

DE 42 38 504 A1 discloses a method in which the reference point is defined by a light barrier. The position of the light barrier, and thus of the reference point, is determined relative to the origin of the coordinate system for the movement of the tool spindle by moving a measuring tool of defined length to the light barrier and detecting the interruption of the light barrier. The relative position of the reference point with regard to the origin of coordinates is determined from the relative position of the tool spindle.

The methods known so far have the disadvantage of requiring to be carried out relatively frequently at least during the phase when thermal equilibrium is being established, and so there is a reduction in the time actually available for machining a workpiece. It is even known in the case of workpieces which are complicated to machine that a measuring tool is inserted into the tool spindle repeatedly during the machining of a workpiece, and the current position of the reference point is determined thereby.

Known machine tools require up to 10 seconds for such a determination of the reference point, and so the known methods for compensating thermal displacement in the case of which the actual displacement is measured substantially reduce the workpiece throughput.

### SUMMARY OF THE INVENTION

In view of the above, it is one object of the present invention to improve the accuracy of the compensation in the known method without having to accept the time disadvantages which are associated with the direct measurement of the actual displacement.

This and other objects are achieved according to the invention by using a calculating rule tuned to the respective machining process.

Specifically, the inventors of the present application have realized that a substantial problem in the known compensation method, which is based on pure temperature measurement, consists in that use is made of a calculating rule which is a function solely of machine type, this calculating rule being determined only once for the appropriate machine type, and not even once is account taken of the individual conditions of the particular machine tools of the corresponding type.

According to the invention, now use is made of a calculating rule which is a function not only of machine type but also of the respective machining process, that is to say of the respective workpiece and the way it is machined.

Specifically, the inventors have realized that the temperature response of a machine tool is not only a purely temporal process after the machine tool has been switched on for the first time, but is also a function of the type of the machining process respectively carried out. Despite an only small number of measuring points, it is possible in this way to compensate thermal displacements accurately such that the direct measurement of the actual displacements can be dispensed with.

Extensive experiments at the applicant's premises have shown that such an individualized calculating rule can be used to compensate thermal displacements by starting solely from temperature values which are detected at various measuring points on the machine tool, doing so with an accuracy which is within the range that is possible by means of direct measurement of the displacements. However, since it is possible to dispense with the actual measurement of the displacements in the new method, this also results in a high workpiece throughput in conjunction with high accuracy. Specifically, the temperature measurements can be carried out at the same time as the machining of a workpiece.

The object on which the invention is based is therefore completely achieved.

According to another object, the calculating rule is tuned to the individual operating situation of the machine tool.

It is advantageous in the case of this measure that not only the respective machining process and the conditions of the individual machine tool, but also the place of installation and the climatic conditions prevailing there feature in the determination of the calculating rule. Specifically, first results with the novel method have shown that it is inadequate under some circumstances when the calculating rule is determined for the corresponding machining process at the applicant's premises for a newly produced machine tool if the machine tool is then used at a completely different place of installation for production purposes.

According to a further object, the calculating rule is determined individually for the respective machining process in the current operating situation.

It is advantageous here that the calculating rule is determined anew on the spot when taking up a new machining process or in the case of a changed operating situation, for example a different place of installation or another time of year. An, as it were, individualized calculating rule is thereby provided which takes account not only of the machine type and the machining process respectively to be carried out, but also of the remainder of the operating situation of the respective individual machine tool.

According to a still further object, the calculating rule is determined by directly measuring the temperature-dependent actual displacements while a machining process is actually being carried out.

It is advantageous in the case of this measure that the calculating rule is determined on the spot, as it were, by carrying out the machining process and respectively measuring the displacement and the current temperature, the calculating rule then being determined or adapted therefrom.

In other words, after a machine tool has been set up at its operating site, the machining process is firstly carried out merely in order to determine the calculating rule for the machining process and the individual operating situation. To this end, the machining process is carried out as in the later series production, the temperature values being detected at the various measuring points. At specific times during the carrying out of the machining process, the actual thermally induced displacement in the machine tool is determined, for example, in the way known from the printed publications DE 42 38 504 or U.S. Pat. No. 5,581,467 mentioned at the outset. It is possible in this way to optimize specific parameters of the calculating rule for the respective machining process, and to optimize the respective operating situation, use being made for this purpose of, for example, known mathematical methods such as the method of least error squares.

As soon as the appropriate parameters have been defined for the calculating rule, a start is made on the actual production process, in which it is then possible to dispense with the measurement of the actual displacements, and thus with a probe, etc., this being so because the temperature response of the machine tool is now described sufficiently accurately by means of the calculating rule. The calculating rule is designed in this case such that workpieces can already be produced with sufficient accuracy directly after an operationally cold machine tool has been switched on. When the machine tool then is heated further in the course of operation, and larger displacements thereby occur, these can likewise be compensated with the aid of the calculating rule.

It is further preferred in this case when the calculating rule is determined during a warm-up phase of the machine tool.

A warm-up phase is understood here as the time from first switching on the operationally cold machine tool up to the reaching of the state of thermal equilibrium, and this lasts several hours, as a rule. After an operationally cold machine tool has been switched on, it is heated as a function of the machining process, the respective site and the current climatic situation, and so a calculating rule determined during the course of the warm-up phase enables the correction of thermal displacements over the temperature range corresponding to the current operating situation and the current machining process.

Thus, during this warm-up phase it is determined which thermal displacements correspond to the respective temperatures at the various measuring points, and which correction values are respectively required for which set of temperature values. The calculating rule is then determined or updated or adapted at the end of the warm-up phase from these data.

According to one object, the directly measured actual displacements are used during the determination of the calculating rule in the warm-up phase to determine correction values, these correction values then currently being used in the machining process.

It is advantageous here that even the workpieces machined during the determination of the calculating rule in the first warm-up phase are sufficiently accurate not to have to be rejected or reworked. Time-consuming direct measurement is necessary only once or seldom, for example given changes in the installation site or the climatic conditions, it nevertheless now being possible to produce workpieces with adequate accuracy even during this phase of the determination of the calculating rule. This is advantageous particularly when the workpieces produced from a very expensive material, and/or the machining of a workpiece lasts a relatively long time such that a loss of production which cannot be neglected can be avoided in accordance with the invention.

According to another object, the direct measurement of the actual displacements during the warm-up phase is performed at measuring instances following one another at a measuring interval, the measuring interval being varied as a function of the displacement determined.

It is advantageous here that the time for determining the calculating rule can be shortened, the point being that the closer the machine tool approaches the state of thermal equilibrium, the larger the measuring interval can become, and this raises the machining speed even during determination of the calculating rule.

It is preferred in general when temperature values from which the calculating rule determines the correction value are measured at a number of measuring points on the machine tool, the calculating rule preferably being a polynomial that describes the dependence of the correction value on the temperature values currently measured at the measuring point and at least one parameter, this parameter being a function of the machining process.

It is advantageous here that the calculating rule itself is of relatively simple design, and so there is a need to determine in each case only the parameter or parameters for the current machining process and, if appropriate, the current operating situation.

It is preferred in general when the machine tool has a moving column which can be traversed relative to the worktable, a spindle head that can be traversed on the moving column and holds the tool spindle, and a chip trough for collecting and removing chips produced during the machining process, at least one measuring point respectively being provided at the moving column, the spindle head and the chip trough.

Experiments on the part of the applicant have revealed that even the temperature values detected at these three measuring points enable the setting up of a calculating rule which can be adapted to the respective machining process such that workpieces can be machined with very high accuracy.

Further advantages follow from the description and the attached drawing.

It goes without saying that the features named above and those still to be explained below can be used not only in the respectively specified combination, but also in other combinations or on their own without departing from the scope of the present invention.

### BRIEF DESCRIPTION OF THE DRAWING

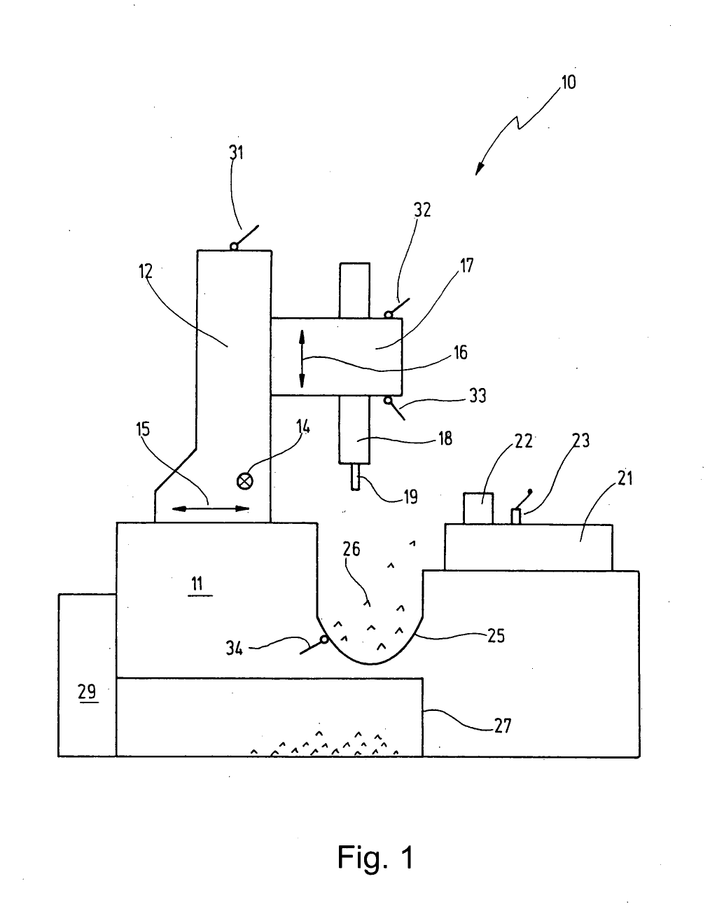

The invention will now be set forth with the aid of a machine tool which is equipped according to the invention with temperature measuring points as shown in FIG. 1.

### DESCRIPTION OF A PREFERRED EMBODIMENT

Denoted by 10 in FIG. 1 is a machine tool which has a machine frame 11 on which a moving column 12 can be traversed in the direction of an X-axis indicated at 14, and in the direction of a Y-axis indicated at 15.

Supported on the moving column 12 is a spindle head 17 which can be traversed in the direction of a Z-axis indicated at 16 and which carries a tool spindle 18 which holds a tool 19 at its lower end. Various tools 19 can be exchanged in the tool spindle 18 in a way known per se.

The tool spindle 18, and thus the respective tool 19, can in this way be traversed on the three axes 14, 15, 16 relative to a work table indicated at 21 and on which a workpiece 22 to be machined is indicated.

In addition to the workpiece 22, a probe 23 which serves as reference point for the coordinate system is provided on the work table 21.

Further indicated between the work table 21 and the moving column 12 is a chip trough 25 in which chips 26 produced during the machining of the workpiece 22 are collected and then removed into a chip container 27.

The traversing instructions to the moving column 12, the spindle head 17 and the tool spindle 18 are supplied via a flow controller indicated at 29.

A first measuring point, indicated at 31, for a first temperature value T₁ is provided on the moving column 12. A second and a third measuring point 32 and 33, respectively, for a second and third temperature value T₂ and T₃, respectively, are provided on the spindle head 17. Finally, a fourth measuring point 34 for a fourth temperature value T₄ is arranged at the chip trough 25.

Stored in the flow controller 29 is a machining process in accordance with which workpieces 22 are now machined one after another. This requires various tools 19 to be clamped into the tool spindle 18 and then to be traversed to various positions on the workpiece 22, in order to carry out milling or drilling work there, for example. To this end, the machining programme includes coordinate sets (Xₛ, Yₛ, Zₛ) which correspond to the respective desired position of the tool 19 for a temperature T₀.

If the machine tool is at a uniform temperature level T₀, no thermal displacements occur, and the machining process can be carried out without correction of the traversing commands. However, this is an unattainable ideal state because, owing to different instances of heating after the machine tool has been switched on, as well as in the course of the machining processes, different parts of the machine tool are again and again at different temperatures. In order to correct the thermal displacements conditioned thereby, the traversing commands of the machine tool are corrected by correction values ΔX, ΔY and ΔZ.
X=Xₛ+ΔX
Y=Yₛ+ΔY
Z=Zₛ+ΔZ

The correction values ΔX, ΔY and ΔZ are calculated as follows as a function of the four measured temperatures T₁, T₂, T₃ and T₄:
ΔX=AₓΔT₁+BₓΔT₂+CₓΔT₃+DₓΔT₄
ΔY=A_{y}ΔT₁+B_{y}ΔT₂+C_{y}ΔT₃+D_{y}ΔT₄
ΔZ=A_{z}ΔT₁+B_{z}ΔT₂+C_{z}ΔT₃+D_{z}ΔT₄

This calculating rule is a first order polynomial.

The determination of ΔX, ΔY and ΔZ is performed via the above calculating rule, in which the parameter sets Aₓ, Bₓ, Cₓ, Dₓ; A_{y}, B_{y}, C_{y}, D_{y} and A_{z}, B_{z}, C_{z}, D_{z} have been determined individually for the respective machining process and the respective operating situation.

As soon as these parameter sets are determined, the correction values ΔX, ΔY and ΔZ can be calculated with the aid of the temperature values T₁, T₂, T₃ and T₄, determined at the measuring points 31, 32, 33 and 34 as well as with the aid of their deviation from a reference temperature T₀. It holds in this case that:
ΔT₁=T₀−T₁
ΔT₂=T₀−T₂
ΔT₃=T₀−T₃
ΔT₄=T₀−T₄

Here, T₀ can be the temperature measured at a further measuring point, or a prescribed value such as, for example, 23° C., in relation to which the correction values ΔX, ΔY and ΔZ vanish. However, it is also possible for the temperature value measured first to be taken as T₀. Furthermore, T₀ can be determined individually for each measuring point.

The parameter sets are, however, determined not only for the machine type, but rather are determined “on the spot” for the respective machining process and the respective operating situation. In this way, it is possible in accordance with the idea of the inventors of the present application to determine over a wide temperature range correction values ΔX, ΔY and ΔZ which permit a very accurate machining of the workpieces 22.

The determination of the calculating rule is now performed in such a way that an operationally cold machine tool is switched on, and on it workpieces 22 are subjected to the machining process, workpieces 22 being machined until the machine tool has terminated its warm-up phase, that is to say is to a certain extent in thermal equilibrium.

During this phase of the determination of the calculating rule, use is made of the probe 23 which is shown in the figure and serves the purpose of repeatedly measuring the current thermal displacement during the course of the machining process, as is described, for example, in detail in the abovementioned DE 42 38 504 A1.

To this end, a measuring tool is exchanged in the tool spindle 18 and then the probe 23 is approached. When the probe 23 responds, the actual position of the probe 23 is compared with the position determined for the temperature T₀, and the actual displacement ΔX, ΔY and ΔZ is determined therefrom. The temperature values T₁, T₂, T₃ and T₄ are also determined in relation to this set of displacements.

Thus, over a time of four hours, for example, the displacements ΔX, ΔY and ΔZ are measured during the warm-up phase for various sets of the temperature values T₁, T₂, T₃ and T₄, from which the parameter sets Aₓ, Bₓ, Cₓ, Dₓ; A_{y}, B_{y}, C_{y}, D_{y} and A_{z}, B_{z}, C_{z}, D_{z} are determined using customary mathematical methods. The method of least error squares is suggested to this end, for example.

These parameter sets now reproduce the thermal displacements of the machine tool 10 over the temperature range traversed during the warm-up phase, doing so accurately in such a way that it is possible with their assistance for the respectively current measured temperature values T₁, T₂, T₃ and T₄ to calculate the correction values ΔX, ΔY and ΔZ so accurately that the workpieces 22 can be very accurately machined.

In order also to be able to use the workpieces machined during determination of the calculating rule or of the parameter sets, the correction values ΔX, ΔY and ΔZ measured during this time are respectively used to compensate traversing commands of the machine controller 29. This prevents workpieces machined during examination of the calculating rule from having to be rejected or reworked.

In order to raise the throughput of the workpieces 22 during determination of the calculating rule, it can further be provided to adapt the time intervals at which the actual current position of the reference point is detected by the probe 23, doing so as a function of the change in the correction values ΔX, ΔY ΔZ in the way it is described in U.S. Pat. No. 5,581,467 mentioned at the outset. The further machine tool 10 approaches the state of thermal equilibrium, the smaller the deviation between consecutive measured correction values ΔX, ΔY and ΔZ becomes, and so the intervals between the individual actual measurements can continue to be enlarged.

After the calculating rule has once been determined in this way for a specific machining process, and a specific operating situation has been determined, workpieces 22 can now be produced with adequate accuracy using the relevant machining process, even directly after a machine tool is switched on in the morning. The thermal displacements in the case of the gradual heating up of the machine tool during operation are sufficiently compensated by the calculating rule. The calculating rule also covers an intermediate cooling of the machine tool for example during a down time as a consequence of a work stoppage, or a cooling owing to short-term opening of a door, or a further heating owing to a rise in ambient temperature.

When the machine tool is brought to another place of installation inside the production shop, or when the climatic conditions change because, for example, it is much hotter there in summer than in winter, it can be necessary to redetermine the parameter sets for the calculating rule.

When the machine tool 10 is reset in the course of its lifetime in order to machine a new workpiece with the aid of a new machining process, it is then necessary to redetermine the calculating rule for this new machining process.

The calculating rule individualized for the respective machining process and the respective operating situation renders it possible to produce workpieces with an accuracy such as has previously been possible only when the current thermal displacement was repeatedly measured during the processing, this being associated with corresponding time losses.

What is claimed is:

1. A method for compensating thermal displacements occurring during the operation of a machine tool, said machine tool having a worktable for mounting workpieces to be machined, and a tool spindle movable relative to the worktable in at least one axis, tools being clampable into said tool spindle for carrying out a machining process on the workpieces,
whereby a calculating rule is used for compensating said thermal displacements,
said calculating rule calculating at least one correction value for the at least one axis from at least one temperature value measured during the performance of the machining process at a measuring point on the machine tool,
whereby the calculating rule is tuned to the respective machining process.

2. The method of claim 1, wherein the calculating rule is tuned to the individual operating situation of the machine tool.

3. The method of claim 2, wherein the calculating rule is determined individually for the respective machining process in the current operating situation.

4. The method of claim 1, wherein the calculating rule is determined by directly measuring the temperature-dependent actual displacements while the machining process is actually being carried out.

5. The method of claim 3, wherein the calculating rule is determined by directly measuring the temperature-dependent actual displacements while the machining process is actually being carried out.

6. The method of claim 4, wherein the calculating rule is determined during a warm-up phase of the machine tool.

7. The method of claim 5, wherein the calculating rule is determined during a warm-up phase of the machine tool.

8. The method of claim 6, wherein the directly measured actual displacements are used during the determination of the calculating rule in the warm-up phase to determine correction values, these correction values then currently being used in the machining process.

9. The method of claim 7, wherein the directly measured actual displacements are used during the determination of the calculating rule in the warm-up phase to determine correction values, these correction values then currently being used in the machining process.

10. The method of claim 8, wherein the direct measurement of the actual displacements during the warm-up phase is performed at measuring instances following one another at a measuring interval, the measuring interval being varied as a function of the displacement determined.

11. The method of claim 9, wherein the direct measurement of the actual displacements during the warm-up phase is performed at measuring instances following one another at a measuring interval, the measuring interval being varied as a function of the displacement determined.

12. The method of claim 1, wherein temperature values from which the calculating rule calculates the correction value are measured at a number of measuring points on the machine tool.

13. The method of claim 5, wherein temperature values from which the calculating rule calculates the correction value are measured at a number of measuring points on the machine tool.

14. The method of claim 9, wherein temperature values from which the calculating rule calculates the correction value are measured at a number of measuring points on the machine tool.

15. The method of claim 11, wherein temperature values from which the calculating rule calculates the correction value are measured at a number of measuring points on the machine tool.

16. The method of claim 1, wherein the calculating rule is a polynomial that describes the dependence of the correction value on the temperature value currently measured at the measuring point and at least one parameter, the parameter being a function of the machining process.

17. The method of claim 5, wherein the calculating rule is a polynomial that describes the dependence of the correction value on the temperature value currently measured at the measuring point and at least one parameter, the parameter being a function of the machining process.

18. The method of claim 8, wherein the calculating rule is a polynomial that describes the dependence of the correction value on the temperature value currently measured at the measuring point and at least one parameter, the parameter being a function of the machining process.

19. The method of claim 11, wherein the calculating rule is a polynomial that describes the dependence of the correction value on the temperature value currently measured at the measuring point and at least one parameter, the parameter being a function of the machining process.

20. The method of claim 15, wherein the calculating rule is a polynomial that describes the dependence of the correction value on the temperature value currently measured at the measuring point and at least one parameter, the parameter being a function of the machining process.

21. The method of claim 1, wherein the machine tool has a moving column which can be traversed relative to the worktable, a spindle head that can be traversed on the moving column and holds the tool spindle, and a chip trough for collecting and removing chips produced during the machining process, at least one measuring point respectively being provided at the moving column, the spindle head and the chip trough.

22. The method of claim 5, wherein the machine tool has a moving column which can be traversed relative to the worktable, a spindle head that can be traversed on the moving column and holds the tool spindle, and a chip trough for collecting and removing chips produced during the machining process, at least one measuring point respectively being provided at the moving column, the spindle head and the chip trough.

23. The method of claim 9, wherein the machine tool has a moving column which can be traversed relative to the worktable, a spindle head that can be traversed on the moving column and holds the tool spindle, and a chip trough for collecting and removing chips produced during the machining process, at least one measuring point respectively being provided at the moving column, the spindle head and the chip trough.

24. The method of claim 11, wherein the machine tool has a moving column which can be traversed relative to the worktable, a spindle head that can be traversed on the moving column and holds the tool spindle, and a chip trough for collecting and removing chips produced during the machining process, at least one measuring point respectively being provided at the moving column, the spindle head and the chip trough.

25. The method of claim 15, wherein the machine tool has a moving column which can be traversed relative to the worktable, a spindle head that can be traversed on the moving column and holds the tool spindle, and a chip trough for collecting and removing chips produced during the machining process, at least one measuring point respectively being provided at the moving column, the spindle head and the chip trough.
